(19) United States
(12) Patent Application Publication
(10) Pub. No.: US 2009/0066536 A1
(43) Pub. Date: Mar. 12, 2009

(54) GROUNDWATER MONITORING SYSTEM

(75) Inventor: Ronald Ruizenaar, Delft (NL)

Correspondence Address: SCHLUMBERGER CANADA LIMITED, 9450 17TH AVE, EDMONTON, AB, T6N 1M9, CA

(73) Assignee: SCHLUMBERGER TECHNOLOGY CORP., SUGAR LAND, TX (US)

(21) Appl. No.: 11/853,960

(22) Filed: Sep. 12, 2007

(51) Int. Cl. G08C 19/16

(52) U.S. Cl. 340/870.01

(57) ABSTRACT

A groundwater monitoring device includes a wireless communications device operable to communicate only within a range of about 150 meters and a sensor package operably associated with the wireless communications device. The wireless communications device includes an antenna, a radio frequency transceiver coupled with the antenna, a processor coupled with the radio frequency transceiver, and an electrochemical cell. The electrochemical cell is electrically coupled with the sensor package, the processor, and the radio frequency transceiver. The electrochemical cell is capable of providing sufficient electrical power to operate the radio frequency transceiver, the sensor package, and the processor for a period of at least a plurality of months.

### BACKGROUND OF THE INVENTION

1. Field of the Invention

The present invention relates to groundwater monitoring systems.

2. Description of Related Art

Groundwater monitoring wells are used to access groundwater for the purposes of determining, among other things, groundwater quality and groundwater level. For example, a sensor system can be suspended in a groundwater monitoring well to sense, collect, and store data concerning the quality and/or quantity (e.g., level) of groundwater accessed by the groundwater monitoring well. Typically, the sensor system is suspended in a locked casing of the groundwater monitoring well into groundwater by a cable or wire. Data is retrieved from the sensor system by withdrawing the sensor system from the well and directly connecting the sensor system to a computer, such as a notebook computer, pocket personal computer, personal digital assistant, or the like. Alternatively, a communication cable may extend from the sensor system to the monitoring well access location, such that data from the sensor system can be retrieved to a computer by direct connection to the communication cable. Data is typically retrieved on a periodic basis, e.g., hourly, daily, monthly, quarterly, yearly.

Accessing such groundwater monitoring wells often presents problems, however. Monitoring wells are often located in remote areas and may be difficult to find, for example, due to changes in terrain resulting from flooding, tidal surges, wind, and the like, or due to changes in vegetation. Monitoring wells may be located on private property and approval for entry to the property may be required to access the monitoring wells. Keys for accessing monitoring wells may not be readily available to personnel tasked with retrieving groundwater data.

Systems have been developed in light of these problems that employ wireless communication methodologies, such as the global system for mobile communications (GSM), satellite, and radio frequency communication methodologies. Such systems, however, are typically too expensive to deploy for groundwater monitoring, as sets of data are only required periodically. Moreover, such systems require significant electrical power and many groundwater monitoring wells are located in areas with little or no access to electrical power.

There are many designs of groundwater monitoring systems well known in the art, however, considerable shortcomings remain.

### BRIEF SUMMARY OF THE INVENTION

In one aspect, a groundwater monitoring device includes a wireless communications device operable to communicate only within a range of about 150 meters and a sensor package operably associated with the wireless communications device. The wireless communications device includes an antenna, a radio frequency transceiver coupled with the antenna, a processor coupled with the radio frequency transceiver, and an electrochemical cell. The electrochemical cell is electrically coupled with the sensor package, the processor, and the radio frequency transceiver. The electrochemical cell is capable of providing sufficient electrical power to operate the radio frequency transceiver, the sensor package, and the processor for a period of at least a plurality of months.

In another aspect, a groundwater monitoring system includes a wireless data retrieving device operable to communicate only within a range of about 150 meters and a groundwater monitoring device. The groundwater monitoring device includes a wireless communications device operable only within a range of about 150 meters and a sensor package operably associated with the wireless communications device. The wireless communications device includes an antenna, a radio frequency transceiver coupled with the antenna, a processor coupled with the radio frequency transceiver, and an electrochemical cell. The electrochemical cell is electrically coupled with the sensor package, the processor, and the radio frequency transceiver. The electrochemical cell is capable of providing sufficient electrical power to operate the radio frequency transceiver, the sensor package, and the processor for a period of at least a plurality of months. The wireless data retrieving device and the wireless communications device are operable to communicate data from the sensor package to the wireless data retrieving device.

The present invention provides significant advantages, including: (1) the ability to remotely record groundwater data; (2) the ability to remotely program settings for groundwater monitoring sensors; (3) providing a groundwater monitoring device that requires little or no maintenance for a period of months or years; (4) the ability to find concealed groundwater monitoring wells; and (5) providing a groundwater monitoring device that can be concealed from view of unauthorized personnel.

### BRIEF DESCRIPTION OF THE DRAWINGS

The novel features characteristic of the invention are set forth in the appended claims. However, the invention itself, as well as a preferred mode of use, and further objectives and advantages thereof, will best be understood by reference to the following detailed description when read in conjunction with the accompanying drawings, in which the leftmost significant digit(s) in the reference numerals denote(s) the first figure in which the respective reference numerals appear, wherein:

FIG. 1 is a stylized view of an illustrative embodiment of a groundwater monitoring device operably associated with a groundwater monitoring well;

FIG. 2 is a block diagram of an illustrative embodiment of a communications device of the groundwater monitoring device of FIG. 1;

FIG. 3 is a block diagram of an illustrative embodiment of a sensor package of the groundwater monitoring device of FIG. 1;

FIG. 4 is a stylized view of an illustrative embodiment of a groundwater monitoring system;

FIG. 5 is a stylized, perspective view of a plurality of groundwater monitoring devices of FIG. 1 and a data retrieving device of FIG. 4;

FIG. 6 is a perspective view of a plurality of groundwater monitoring devices of FIG. 1 and the data retrieving device of FIG. 4 being operated by a human;

FIG. 7 is a stylized, side, elevational view of the data retrieving device of FIG. 4 operably associated with a vehicle; and

FIG. 8 is a graphical representation of an exemplary network configuration of a plurality of groundwater monitoring devices of FIG. 1 and a data retrieving device of FIG. 4.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

A groundwater monitoring system includes one or more groundwater monitoring devices and a data retrieving device that communicate in a wireless fashion. Preferably, the one or more groundwater monitoring devices and the data retrieving device communicate using very low power radio methodologies, such as those defined by IEEE Standard 802.15.4, promulgated by the Institute of Electrical and Electronics Engineers, Inc. of New York, N.Y., USA, and by “ZigBee” wireless device specification, promulgated by ZigBee Alliance, Inc. of San Ramon, Calif., USA.

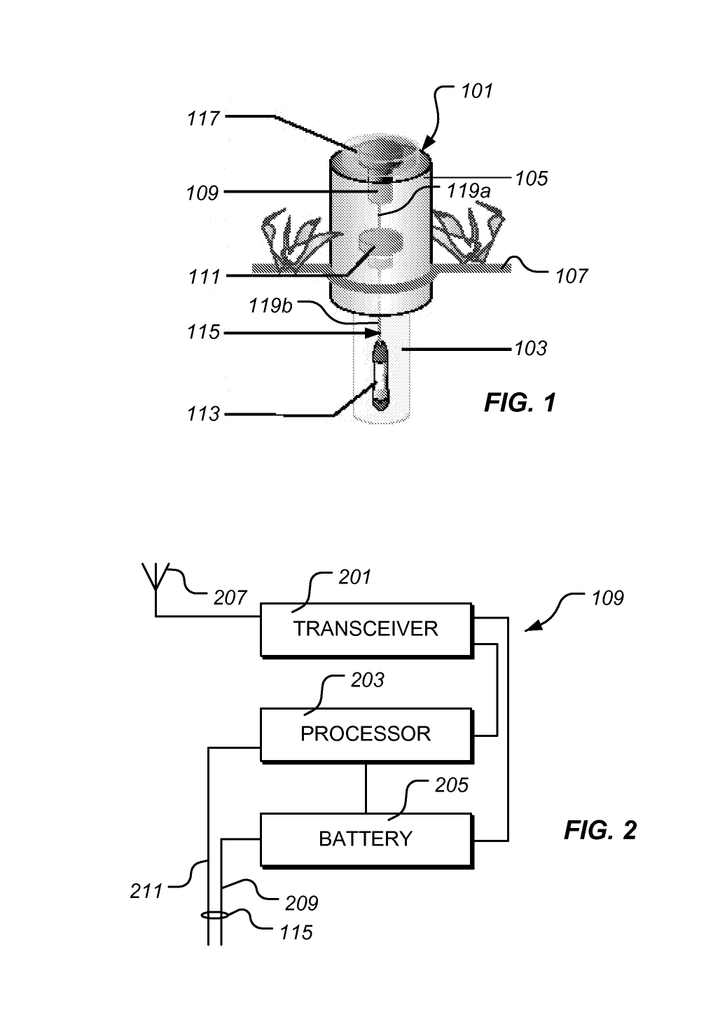

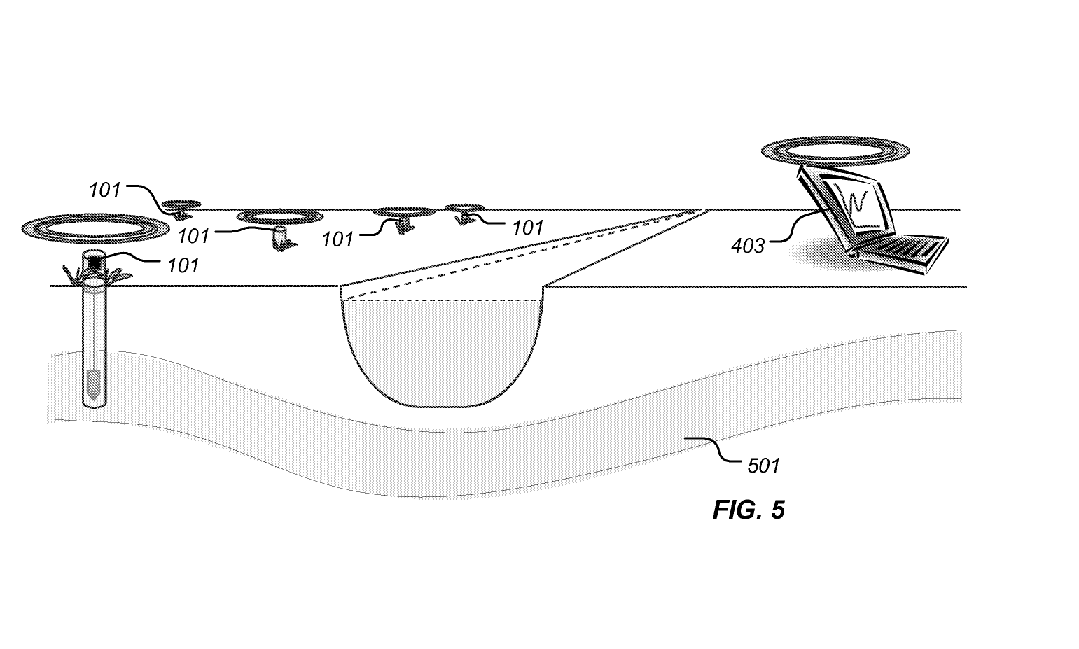

FIG. 1 depicts a stylized, illustrative embodiment of a groundwater monitoring device 101 operatively associated with a well casing 103 and a well cap 105. Well casing 103 extends below ground level, generally at 107, from well cap 105. Well cap 105 extends above ground level 107, substantially seals off well casing 103, and inhibits unauthorized tampering with objects disposed within well casing 103 and/or well cap 105. In the illustrated embodiment, groundwater monitoring device 101 comprises a wireless communications device 109, a strain relief 111, a sensor package 113, a communication cable 115, and a housing 117. Strain relief 111 may be omitted in certain embodiments. Cable 115 comprises an upper portion 119a and a lower portion 119b. Upper portion 119a of cable 115 extends between communications device 109 and strain relief 111. Lower portion 119b of cable 115 extends between strain relief 111 and sensor package 113. Sensor package 113 is disposed within well casing 103 and is suspended within groundwater, such as groundwater 501 of FIG. 5, by cable 115. Communication signals and, preferably, electrical power propagates between communications device 109 and sensor package 113 via cable 115. Preferably, communications device 109 provides electrical power to sensor package 113. Housing 117 conceals internal elements of communications device 109 in such a way that communications device 109 can be accessed by authorized personnel, inhibits fluids from entering communications device 109, protects internal elements of communications device 109 from electromagnetic interference, and is substantially immune from corrosion.

FIG. 2 is a block diagram depicting an illustrative embodiment of communications device 109. Communications device 109 is operable to communicate only within a range of about 150 meters. In the illustrated embodiment, communications device 109 comprises a radio frequency transceiver 201, a processor 203, and an electrochemical cell, such as a battery 205. Transceiver 201 is coupled with an antenna 207 for transmitting and receiving radio frequency signals. Battery 205 provides electrical power to processor 203 and transceiver 201. Battery 205 also provides electrical power to sensor package 113 via one or more lines 209 of cable 115. Preferably, battery 205 has sufficient capacity to power processor 203, transceiver 201, and sensor package 113 for a period of at least a plurality of months and, more preferably, a period exceeding a year. Processor 203 communicates with sensor package 113 via one or more lines 211 of cable 115. Processor 203 controls transceiver 201.

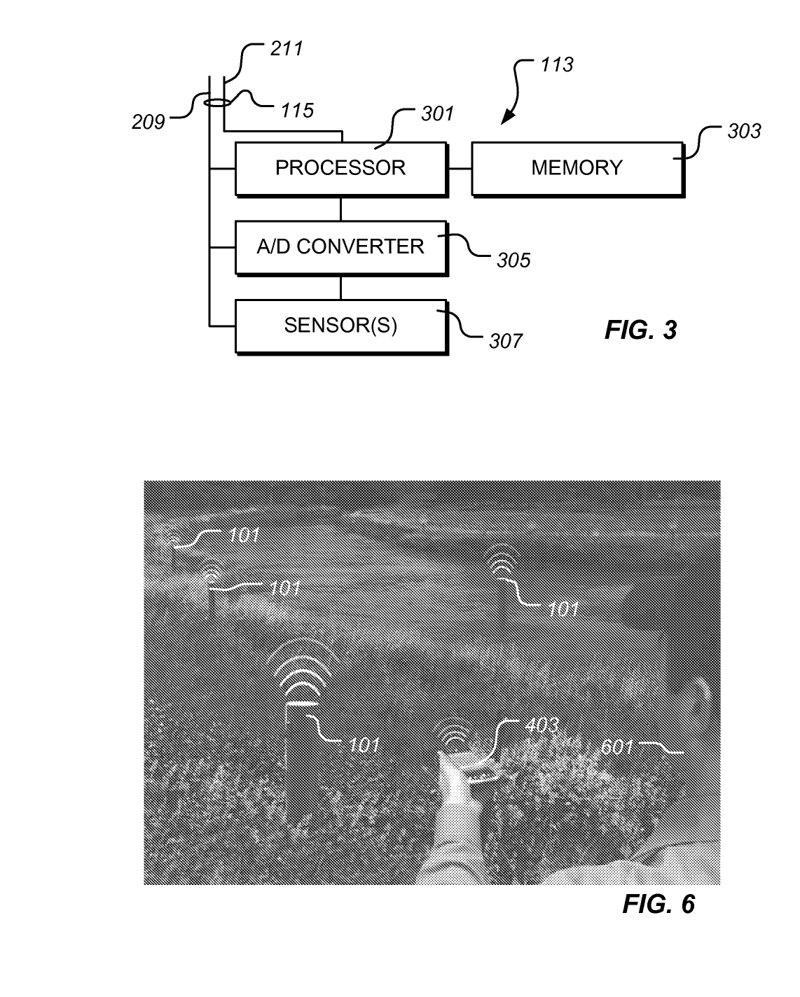

FIG. 3 is a block diagram depicting an illustrative embodiment of sensor package 113, comprising a processor 301, memory 303, an analog-to-digital (A/D) converter 305, and one or more sensors 307. Electrical power is provided to processor 301, memory 303, A/D converter 305, and the one or more sensors 307 by battery 205 (shown in FIG. 2) via one or more lines 209 of cable 115. The one or more sensors 307 may comprise any sensors useful in sensing a level or characteristic of groundwater. For example, the one or more sensors 307 may comprise pressure, temperature, and/or conductivity sensors. The one or more sensors 307 output signals corresponding to the parameters being measured. In the illustrated embodiment, the one or more sensors 307 output analog electrical signals to A/D converter 305, which converts the analog electrical signals to digital electrical signals. A/D converter 305 outputs the digital signals to processor 301, which stores representations of the digital signals, along with other data such as time, date, and the like, to memory 303. Processor 301 communicates with processor 203 of communications device 109 via the one or more lines 211.

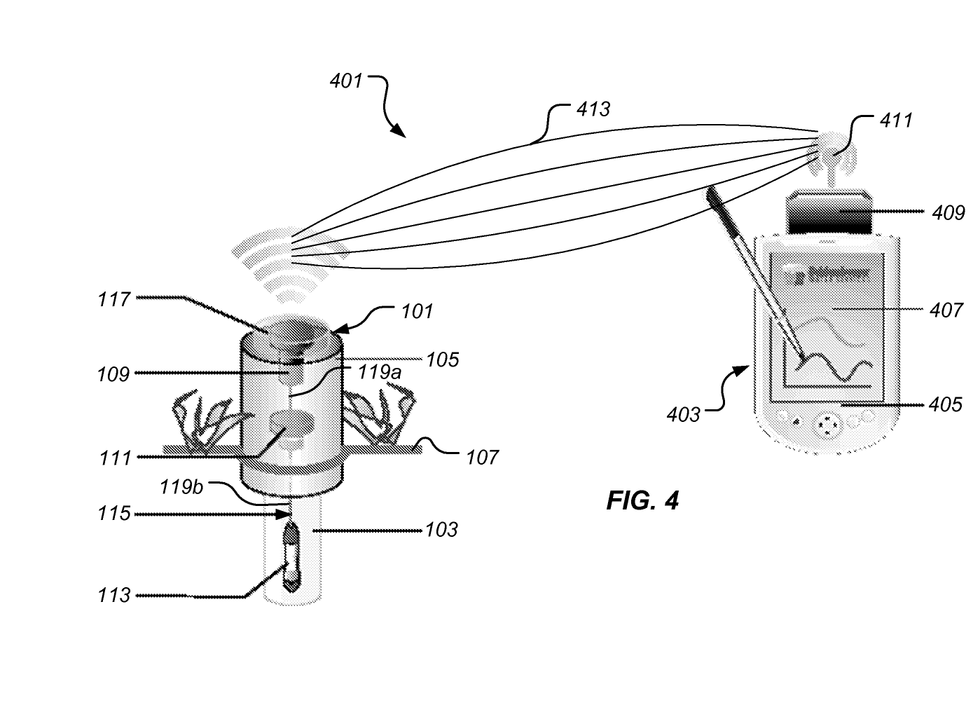

FIG. 4 is a stylized diagram depicting an illustrative embodiment of a groundwater monitoring system 401. In the illustrated embodiment, groundwater monitoring system 401 comprises groundwater monitoring device 101 and a data retrieving device 403. While data retrieving device 403 may take many forms contemplated by the present invention, data retrieving device 403 of FIG. 4 is embodied in a hand-held computer 405, such as a “pocket PC,” or “personal digital assistant.” In the illustrated embodiment, computer 405 includes a graphical user interface 407 that allows a user to communicate with data retrieving device 403. Data retrieving device 403 comprises a transceiver 409 and an antenna 411 for wirelessly communicating with groundwater monitoring device 101, represented by graphic 413. Specifically, transceiver 409 of data retrieving device 403 wirelessly communicates with transceiver 201 of groundwater monitoring device 101 via radio frequency signals propagated via antennas 207 and 411.

Referring to FIGS. 2-4, data retrieving device 403 includes hardware and software components that, in concert, command groundwater monitoring device 101 to wirelessly transmit groundwater data stored in memory 303 to data retrieving device 403. Upon successful transmission of the data stored in memory 303, memory 303 is cleared. Data retrieving device 403 operates in this way to obtain data from one or more groundwater monitoring devices 101, as shown in FIG. 5. In one embodiment, data retrieving device 403 is operable with groundwater monitoring device 101 when disposed within a distance of not more than about 150 meters from groundwater monitoring device 101. Data retrieving device 403 may also be used as a “bip indicator” for aiding in determining locations of groundwater monitoring devices 101 that may be concealed. Moreover, data retrieving device 403 may transmit settings or parameters for operation of sensor package 113 to communications device 109, which communications device 109 subsequently transmits to sensor package 113 via cable 115.

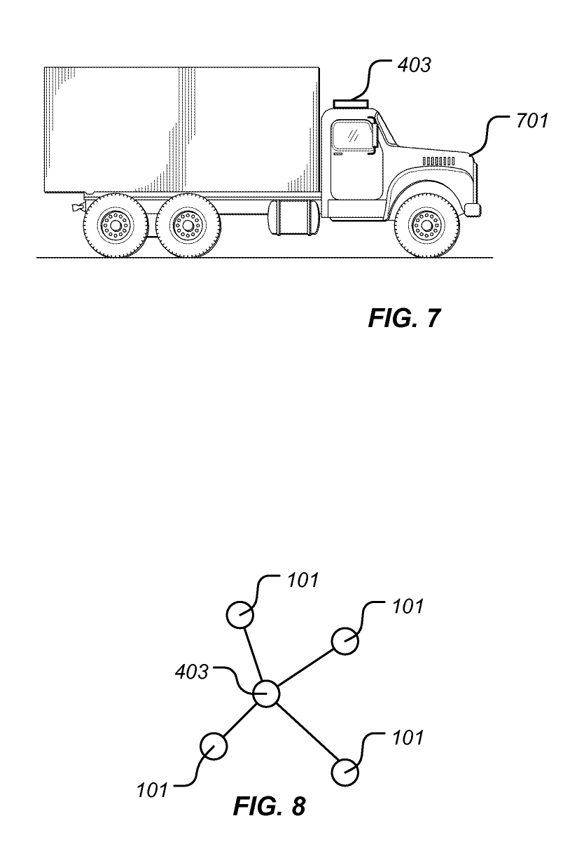

It should be noted that the present invention contemplates data retrieving devices other than data retrieving device 403 of FIG. 4. A data retrieving device of the present invention may be constructed of any device operable to communicate with communications device 109 of groundwater monitoring device 101 and retrieve data from groundwater monitoring device 101 whether transported by a human 601, such as that shown in FIG. 6; an animal; or a vehicle 701, such as that shown in FIG. 7, to a zone proximate groundwater monitoring device 101.

Preferably, communications device 109 and data retrieving device 403 operate under the protocol defined by IEEE Standard 802.15.4, promulgated by the Institute of Electrical and Electronics Engineers, Inc. of New York, N.Y., USA, which is incorporated herein in its entirety by reference. In another embodiment, communications device 109 and data retrieving device 403 operate under the protocol defined by IEEE Standard 802.15.4-2003, also incorporated herein in its entirety by reference. In yet another embodiment, communications device 109 and data retrieving device 403 operate under the protocol defined by IEEE Standard 802.15.4-2006, also incorporated herein in its entirety by reference. Preferably, groundwater monitoring devices 101 and data retrieving device 403 operate according to a methodology defined by ZigBee Specification Document 053474r13, promulgated by ZigBee Alliance, Inc. of San Ramon, Calif., USA, which is incorporated herein by reference.

Preferably, wireless communications between communications device 109 and data retrieving device 403 are accomplished in at least one of an 868/915 MHz direct sequence spread spectrum mode employing binary phase-shift keying modulation; an 868/915 MHz direct sequence spread spectrum mode employing offset quadrature phase-shift keying modulation; an 868/915 MHz parallel sequence spread spectrum mode employing binary phase-shift keying modulation; and a 2450 MHz direct sequence spread spectrum mode employing offset quadrature phase-shift keying modulation.

Groundwater monitoring devices 101 and data retrieving device 403 can be configured in many different network configurations. FIG. 8 depicts one such exemplary configuration. For example, in FIG. 8, groundwater monitoring devices 101 and data retrieving device 403 are configured in a “star” network configuration. In this configuration, groundwater monitoring devices 101 communicate directly with data retrieving device 403. Preferably, communications devices 109 (shown in FIGS. 1 and 2) of groundwater monitoring devices 101 are operated in a mode requiring minimal electricity consumption, such as “hibernation.” Upon receiving a signal from data retrieving device 403, communications devices 109 of one or more groundwater monitoring devices 101 within range are awakened and data is transferred from the one or more groundwater monitoring devices 101 to data retrieving device 403. After transferring the data, communications devices 109 of the one or more groundwater monitoring devices 101 return to hibernation to conserve electrical energy.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Although the present invention is shown in a limited number of forms, it is not limited to just these forms, but is amenable to various changes and modifications. Accordingly, the protection sought herein is as set forth in the claims below.

What is claimed is:

1. A groundwater monitoring device, comprising:
a wireless communications device operable to communicate only within a range of about 150 meters, the wireless communications device comprising:
an antenna;
a radio frequency transceiver coupled with the antenna;
a processor coupled with the radio frequency transceiver; and
an electrochemical cell; and
a sensor package operably associated with the wireless communications device;
wherein the electrochemical cell is electrically coupled with the sensor package, the processor, and the radio frequency transceiver, the electrochemical cell being capable of providing sufficient electrical power to operate the radio frequency transceiver, the sensor package, and the processor for a period of at least a plurality of months.

2. The groundwater monitoring device, according to claim 1, further comprising:
a housing in which the wireless communications device is sealed from fluid entry.

3. The groundwater monitoring device, according to claim 1, wherein the groundwater monitoring device is operably associated with a cap of a groundwater monitoring well.

4. The groundwater monitoring device, according to claim 1, wherein the wireless communications device operates in an 868/915 MHz direct sequence spread spectrum mode employing binary phase-shift keying modulation.

5. The groundwater monitoring device, according to claim 1, wherein the wireless communications device operates in an 868/915 MHz direct sequence spread spectrum mode employing offset quadrature phase-shift keying modulation.

6. The groundwater monitoring device, according to claim 1, wherein the wireless communications device operates in an 868/915 MHz parallel sequence spread spectrum mode employing binary phase-shift keying modulation.

7. The groundwater monitoring device, according to claim 1, wherein the wireless communications device operates in a 2450 MHz direct sequence spread spectrum mode employing offset quadrature phase-shift keying modulation.

8. A groundwater monitoring system, comprising:
a wireless data retrieving device operable only within a range of about 150 meters; and
a groundwater monitoring device, comprising:
a wireless communications device operable to communicate only within a range of about 150 meters; the wireless communications device comprising:
an antenna;
a radio frequency transceiver coupled with the antenna;
a processor coupled with the radio frequency transceiver; and
an electrochemical cell; and
a sensor package operably associated with the wireless communications device;
wherein the electrochemical cell is electrically coupled with the sensor package, the processor, and the radio frequency transceiver, the electrochemical cell being capable of providing sufficient electrical power to operate the radio frequency transceiver, the sensor package, and the processor for a period of at least a plurality of months; and
wherein the wireless data retrieving device and the wireless communications device are operable to communicate data from the sensor package to the wireless data retrieving device.

9. The groundwater monitoring system, according to claim 8, further comprising:
a housing in which the wireless communications device is sealed from fluid entry.

10. The groundwater monitoring system, according to claim 8, wherein the groundwater monitoring device is operably associated with a cap of a groundwater monitoring well.

11. The groundwater monitoring system, according to claim 8, wherein the wireless communications device operates in an 868/915 MHz direct sequence spread spectrum mode employing binary phase-shift keying modulation.

12. The groundwater monitoring system, according to claim 8, wherein the wireless communications device operates in an 868/915 MHz direct sequence spread spectrum mode employing offset quadrature phase-shift keying modulation.

13. The groundwater monitoring system, according to claim 8, wherein the wireless communications device operates in an 868/915 MHz parallel sequence spread spectrum mode employing binary phase-shift keying modulation.

14. The groundwater monitoring system, according to claim 8, wherein the wireless communications device operates in a 2450 MHz direct sequence spread spectrum mode employing offset quadrature phase-shift keying modulation.

15. The groundwater monitoring system, according to claim 8, wherein the wireless data retrieving device is a hand-held computer.

16. The groundwater monitoring system, according to claim 8, wherein the wireless data retrieving device is operably associated with a vehicle.
